(19) United States
(12) Patent Application Publication
(10) Pub. No.: US 2024/0042807 A1
(43) Pub. Date: Feb. 8, 2024

(54) COMMERCIAL VEHICLE TYRE

(71) Applicant: Continental Reifen Deutschland GmbH, Hannover (DE)

(72) Inventors: David Markovic, Hannover (DE); Volkmar Fries, Wedemark (DE)

(73) Assignee: Continental Reifen Deutschland GmbH, Hannover (DE)

(21) Appl. No.: 18/257,062

(22) PCT Filed: Nov. 29, 2021
(86) PCT No.: PCT/DE2021/200212

§ 371 Date: Jun. 12, 2023

(30) Foreign Application Priority Data
Dec. 11, 2020 (DE) 10 2020 215 727.8

(51) Int. Cl. B60C 15/024

(52) U.S. Cl. CPC B60C 15/024; B60C 2015/0245; B60C 2200/06

(57) ABSTRACT

A commercial vehicle tire intended for mounting on an E.T.R.T.O. Standards Manual standardized 15° drop-center rim (width codes 5.25 to 9.75) with two rim flanges (2) and with two rim sections (3), each with a bead seat surface (3a),
wherein the commercial vehicle tire has two bead regions with bead cores (4) and in each case one bead toe (6) and one bead contour on the outside of the tire and one on the inside of the tire, which bead contours adjoin one another at the bead toe (6), wherein each bead contour on the outside of the tire has a first segment (S₁), which is in contact with the rim flange (2) when the commercial vehicle tire is mounted on the rim (1), and an outer contour region, which is at least partially in contact with the bead seat surface (3a) when the commercial vehicle tire is mounted on the rim (1).

The outer contour region is made up of three adjoining segments (S₂, S₃, S₄), specifically a second segment (S₂) which adjoins the first segment (S₁), which comes into contact with the rim flange (2), at an external angle (β₁) of 190° to 225°, a third segment (S₃) which adjoins this second segment at an external angle (β₂) of 165° to 175°, and a fourth segment (S₄) which adjoins this third segment at an external angle (β₃) of 200° to 210°,
wherein the total width (B) of the second, third and fourth segments (S₂, S₃, S₄), projected onto a reference line (g₂) running at an angle (α′) of 15° in relation to the second segment (S₂), is 20.0 mm to 45.0 mm and wherein the fourth segment (S₄) has a width (b₄) of 20% to 35% of the total width (B) in this projection.

The invention relates to a commercial vehicle tire intended for mounting on an E.T.R.T.O. Standards Manual standardized 15° drop-center rim (width codes 5.25 to 18.00) with two rim flanges and with two rim sections, each with a bead seat surface,
wherein the commercial vehicle tire has two bead regions with bead cores and in each case one bead toe and one bead contour on the outside of the tire and one on the inside of the tire, which bead contours adjoin one another at the bead toe, wherein each bead contour on the outside of the tire has a first segment, which is in contact with the rim flange when the commercial vehicle tire is mounted on the rim, and an outer contour region, which is at least partially in contact with the bead seat surface when the commercial vehicle tire is mounted on the rim.

A commercial vehicle tire of this kind is known, for example, from EP 1 240 033 B1. In one embodiment, shown in this document, of a bead region for the commercial vehicle tire, the bead contour region on the outside of the tire, which bead contour region is in contact with the bead seat surface of the rim when the commercial vehicle tire is mounted on the rim, is uniformly shaped in the form of a truncated cone. The bead contour on the inside of the tire and the bead contour on the outside of the tire meet at the bead toe tip and run in relation to one another at an opening angle of 105° to 155°. Bead toes designed in this way are intended to ensure that the tire beads remain intact as far as possible when the tire is mounted on the rim. EP 1 240 033 B1 discloses a further exemplary embodiment of a bead contour with a strongly rounded bead toe in order to facilitate mounting of the tire. The production of commercial vehicle tires with such bead contours, however, requires very specially designed vulcanization molds.

The design of the bead regions extensively influences the extent to which a commercial vehicle tire can be mounted without damaging the bead regions and whether additional mounting aids (such as tire shock fillers) are required for inflation. It is known that, in the case of commercial vehicle tires, there is a conflict of objectives between low bead toe deformation and good mountability, i.e. design measures which reduce bead toe deformation usually result in worse mountability, and vice versa. Deformation of the bead toes usually occurs only when the mounted commercial vehicle tires are used and can be such that the commercial vehicle tires can no longer be retreaded. The undesired bead toe deformation can be kept small due to the design of the bead toe. A reduction in bead toe deformation via special bead contours generally requires higher mounting forces and therefore also increases the risk of damage during mounting. Since the bead toes also have an important function in respect of the airtightness of the commercial vehicle tire, it is customary to provide commercial vehicle tires with elongated, pointed bead toes, which have an adverse effect on the ease of mounting of the tires. In order to reduce bead toe deformations and to improve the ability to mount commercial vehicle tires on rims, alternative solutions, for example rim band protectors, have also been proposed. These measures require additional material and processing costs.

The invention is based on the object of designing the bead regions in a commercial vehicle tire in such a way that the conflict of objectives between ease of mounting and bead toe deformation is resolved as optimally as possible by ensuring that the commercial vehicle tire can be mounted in a convenient manner without bead toe deformation and remains airtight.

According to the invention, the stated object is achieved in that the outer contour region is made up of three adjoining segments, specifically a second segment which adjoins the first segment, which comes into contact with the rim flange, at an external angle of 190° to 225°, a third segment which adjoins this second segment at an external angle of 165° to 175°, and a fourth segment which adjoins this third segment at an external angle of 200° to 210°,
wherein the total width of the second, third and fourth segments, projected onto a reference line running at an angle of 15° in relation to the second segment, is 20.0 mm to 45.0 mm and wherein the fourth segment has a width of 20% to 35% of the total width in this projection.

Bead regions designed according to the invention have an outer contour region, which comes into contact with the bead seat surface of the rim and is divided into three segments which run at an angle to one another in a specific way, in such a way that the ability to mount the tire is significantly improved, with the ability to inflate the tire and the airtightness, in particular due to the course and the width of the fourth segment, being effectively maintained. The specific angulations between the four segments reduce plastic deformation of the bead regions of the commercial vehicle tire and therefore also ensure low bead toe deformation, which is associated with low bead flange deformation of the rim. Commercial vehicle tires with bead regions designed in this way are also distinguished by high bead durability.

Further preferred measures contribute to reducing the plastic deformation of the bead regions of the commercial vehicle tire and ensuring low bead toe deformation.

According to one of these measures, the second segment has a width of 40% to 60% of the total width.

According to further advantageous measures in this regard, the second, the third and the fourth segment, as viewed over the circumference of the bead region, are truncated cone lateral surfaces or similar to truncated cone lateral surfaces, and the first segment is either a truncated cone lateral surface or a cylinder lateral surface or similar to such lateral surfaces.

With a view to achieving low bead toe deformation, it is also advantageous if the bead contour on the inside of the tire has an end section which, together with the fourth segment, defines the bead toe with a toe tip, wherein this end section, at the toe tip, forms an angle, of 80° to 90°, with the fourth segment. This end section preferably extends substantially as far as the inner edge of the bead core. Adjoining the end section, the bead contour on the inside of the tire preferably runs in such a way that the angles between the fourth segment and tangents to the bead contour on the inside of the tire become smaller as the distance from the fourth segment increases.

A further measure, by way of which the toe tip, which is particularly sensitive with regard to bead toe deformation, is protected against undesired deformations and optimum tire airtightness is ensured, is that the fourth segment, at the bead toe, has an end section which has a width of 2.00 mm to 5.00 mm and runs in a rounded manner in the direction of the tire axis, not shown, with a radius of 0.50 mm to 3.00 mm.

Deformations of the bead regions when mounting the commercial vehicle tire are also kept low in particular when the individual segments adjoin one another via rounded transitions with a radius of, for example, 1.00 mm to 10.00 mm.

The bead cores preferably consist of rubberized steel wires, so that the bead cores can be deformed more easily when the commercial vehicle tire is mounted.

Further features, advantages and details of the invention will now be described in more detail with reference to the schematic drawing, which illustrates an exemplary embodiment. In the drawing:

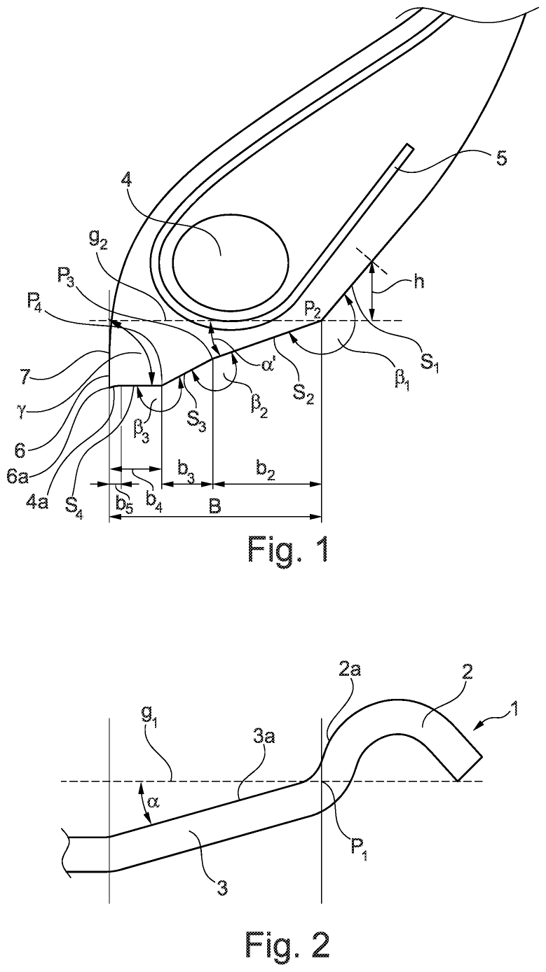

FIG. 1 shows a bead region of a commercial vehicle tire in axial section or cross section, and

FIG. 2 shows an associated sectional view of a section of a 15° drop-center rim.

FIG. 1 shows, in cross section, a bead region of a commercial vehicle tire, for example a tire for trucks or buses. Commercial vehicle tires with bead regions designed according to the invention are intended for mounting on 15° drop-center rims, designed in accordance with the European Tyre and Rim Technical Organisation Standards Manual, as amended, sections “15° Drop-Center Rims (width codes 5.25 to 18.00) with nominal diameters of 17.5 inches, 19.5 inches, 20.5 inches, 22.5 inches or 24.5 inches.

FIG. 2 shows a sectional view through an edge section of a rim 1, which is a 15° drop-center rim, as mentioned. Said figure shows, in cross section, a rim flange 2 with a seat surface 2a on the inside of the rim and a rim section 3 inclined at an angle α of 15° in relation to the rim axis (rotation axis of the rim 1), not shown, and in the direction of the drop center with a bead seat surface 3a on the inside of the rim and also running at an angle α of 15° in relation to the rotation axis, not shown, of the rim 1. The seat surface 2a on the rim flange 2 and the bead seat surface 3a intersect one another along a circle encircling the rim 1, which in the cross section shown is symbolized by a point P₁. The diameter of this circle corresponds to the respective rim diameter. In FIG. 2, the angle α is drawn between the bead seat surface 3a and a dashed reference line g₁ running parallel to the rim axis, not shown, through the point P₁.

FIG. 1 shows the bead region, as it is formed in a vulcanized commercial vehicle tire, before the commercial vehicle tire is mounted on the rim 1. The bead region shown in FIG. 1 contains a bead core 4, which is drawn schematically and is round in the example, made of rubberized steel wires and a carcass layer 5, which is also merely indicated, surrounding the bead core 4. Other components that usually reinforce the bead region, such as bead reinforcement layers, are not shown.

The bead contour, on the outside of the tire, of the bead region is divided into four flat, directly successive segments, which are designated S₁, S₂, S₃ and S₄, at least partially come into contact with the rim 1 when the commercial vehicle tire is mounted and are at least partially in contact in the mounted state. By way of the segment S₁, the bead region is in contact with the seat surface 2a of the rim flange 2 in the mounted state. The segments S₂ to S₄ are those that are partially or completely in contact with the bead seat surface 3a of the rim 1 when the commercial vehicle tire is mounted and in the mounted state usually of the commercial vehicle tire. Each segment S₁ to S₄ is a straight line in the bead cross section, and an annularly encircling surface on the bead of the commercial vehicle tire. Here, the segments S₂, S₃ and S₄ are truncated cone lateral surfaces, and the segment S₁ is either a truncated cone lateral surface or a lateral surface of a circular cylinder.

A point P₂ is drawn in FIG. 1, this point substantially coinciding with the point P₁ of the rim 1 and being located on the intersection circle encircling the bead region of the tire between the segment S₁ and the segment S₂. At the intersection P₂, the segment S₁ forms an external angle β₁, of 190° to 225°, with the segment S₂. A reference line g₂ which runs in the axial direction and at an internal angle α′ of 15° in relation to the segment S₂ and, in the example, passes through the point P₂ is also drawn in FIG. 1. In particular, the reference line g₂ can run parallel to the rotation axis of the tire. Along another intersection circle encircling the bead region of the tire, which intersection circle is identified in FIG. 1 by a point P₃, the segment S₃ adjoins the segment S₂. The segments S₂ and S₃ form an obtuse external angle β₂ of 165° to 175° with one another. A point P₄ lies on another intersection circle present at the transition of the segment S₃ into the segment S₄ and encircling the bead region of the tire. The segments S₃ and S₄ form an external angle β₃ of 200° to 210° with one another.

The first segment S₁, which comes into contact with the seat surface 2a of the rim flange 2, extends from the reference line g₂ determined at a right angle up to a height h which corresponds at least to the rim flange height, so that h is usually ≥13.00 mm.

On the reference line g₂ projected in FIG. 1, the segments S₂ to S₄ run together or in total over a width B equal to 20.00 mm to 45.00 mm, depending on the tire dimension. The segment S₂ has a width b₂, the segment S₃ has a width b₃ and the segment S₄ has a width b₄. The width b₂ of the segment S₂ is 40% to 60%, in particular 45% to 55%, of the width B. The width b₄ of the segment S₄ is 20% to 35% of the width B, and the width b₃ is adapted in accordance with the widths b₂ and b₄.

The bead region has, on the inside of the tire, a bead contour, on the inside of the tire, which runs in a rounded manner overall and has an end section 7 which, together with the segment S₄, defines a bead toe 6 with a toe tip 6a. At the bead toe 6, the end section 7 of the bead contour on the inside of the tire (see drawn tangent) forms an internal angle γ, of 80° to 90°, with the segment S₄. The end section 7 of the bead contour, on the inside of the tire, of the bead region extends substantially as far as the lower or inner edge of the bead core 4. To the side of the bead core 4, the angle between tangents to the bead contour on the inside of the tire and the segment S₄ decreases continuously, until this angle above the bead core 4 is of the order of magnitude of 35° to 45°.

Adjoining the toe tip 6a, the segment S₄ has an end section 4a which has a width b₅ of 2.0 mm to 5.0 mm and runs in a rounded manner in the direction of the tire axis, not shown, with a radius of 0.5 mm to 3.0 mm. The toe tip 6a can additionally be chamfered at an angle.

The transitions between the individual segments S₁, S₂, S₃ and S₄ are drawn as fold lines, but can also be slightly rounded, and therefore provided, for example, with rounded transitions with a small radius of the order of magnitude of 1.0 mm to 10.0 mm.

### LIST OF REFERENCE SIGNS

1 Rim
2 Rim flange
2a Seat surface
3 Rim section
3a Bead seat surface
4 Bead core
5 Carcass layer
6 Bead toe
6a Toe tip
7 End section
h Height
g₁, g₂ Reference line
B Width
b₁, b₂, b₃ Width
P₁, P₂, P₃, P₄ Point
S₁, S₂ Segment
S₃, S₄ Segment
α, α′ Angle
β₁, β₂, β₃ External angle
γ Internal angle

1-10. (canceled)

11. A commercial vehicle tire comprising:
two rim flanges and with two rim sections, each with a bead seat surface,
wherein the commercial vehicle tire has two bead regions with bead cores and in each case one bead toe and one bead contour on the outside of the tire and one on the inside of the tire, which bead contours adjoin one another at the bead toe, wherein each bead contour on the outside of the tire has a first segment (S₁), which is in contact with the rim flange when the commercial vehicle tire is mounted on the rim, and an outer contour region, which is in contact with the bead seat surface when the commercial vehicle tire is mounted on the rim;
wherein the outer contour region is made up of three adjoining segments (S₂, S₃, S₄), which include a second segment (S₂) which adjoins the first segment (S₁), which comes into contact with the rim flange (2), at an external angle (β₁) of 1900 to 225°, a third segment (S₃) which adjoins this second segment at an external angle (β₂) of 1650 to 175°, and a fourth segment (S₄) which adjoins this third segment at an external angle (β₃) of 2000 to 210°;
wherein a total width (B) of the second, third and fourth segments (S₂, S₃, S₄), projected onto a reference line (g₂) running at an angle (α′) of 15° in relation to the second segment (S₂), is 20.0 mm to 45.0 mm and wherein the fourth segment (S₄) has a width (b₄) of 20% to 35% of the total width (B) in this projection.

12. The tire of claim 11, wherein the second segment (S₂) has a width (b₂) of 40% to 60% of the total width (B).

13. The tire of claim 11, wherein the second, the third and the fourth segment (S₂, S₃, S₄), as viewed over the circumference of the bead region, are truncated cone lateral surfaces or similar to truncated cone lateral surfaces.

14. The tire of claim 11, wherein the first segment (S₁), as viewed over the circumference of the bead region, is either a truncated cone lateral surface or a cylinder lateral surface or similar to such lateral surfaces.

15. The tire of claim 11, wherein the bead contour on the inside of the tire has an end section (7) which, together with the fourth segment (S₄), defines the bead toe (6) with a toe tip (6a), wherein the end section (7), at the toe tip (6a), forms an angle (γ), of 80° to 90°, with the fourth segment (S₄).

16. The tire of claim 11, wherein the end section (7) of the bead contour, on the inside of the tire, of the bead region extends substantially as far as the inner edge of the bead core (4).

17. The tire of claim 11, wherein the bead contour on the inside of the tire runs outside the end section (7) in such a way that the angles between the fourth segment (S₄) and tangents to the bead contour on the inside of the tire become smaller as the distance from the fourth segment (S₄) increases.

18. The tire of claim 11, wherein the fourth segment (S₄), at the bead toe (6), has an end section (4a) which has a width (b₅) of 2.0 mm to 4.0 mm and runs in a rounded manner in the direction of the tire axis, not shown, with a radius of 0.5 mm to 3.0 mm.

19. The tire of claim 11, wherein the individual segments (S₁, S₂, S₃ and S₄) adjoin one another via rounded transitions with a radius of, for example, 1.0 mm to 10.0 mm.

20. The tire of claim 11, wherein the bead cores (4) consist of rubberized steel wires.

21. The tire of claim 11, the tire mounted on an E.T.R.T.O. Standards Manual standardized 15° drop-center rim (width codes 5.25 to 18.00).
